(19) United States
(12) Patent Application Publication
(10) Pub. No.: US 2006/0200806 A1
(43) Pub. Date: Sep. 7, 2006

(54) Apparatus, system, and method for trace insertion

(76) Inventor: Khan Muluh Tasinga, San Jose, CA (US)

Correspondence Address: KUNZLER & ASSOCIATES, 8 EAST BROADWAY, SUITE 600, SALT LAKE CITY, UT, 84111, US

(21) Appl. No.: 11/074,180

(22) Filed: Mar. 7, 2005

(51) Int. Cl. G06F 9/44

(52) U.S. Cl. 717/128

(57) ABSTRACT

An apparatus, system, and method are disclosed for inserting a trace statement into a compiled class file. A trace statement may be an entry, exit, exception, or other type of trace statement. The apparatus includes a source code module, a generation module, and an insertion module. The source code module identifies compiled source code. The generation module generates an insertion code to facilitate insertion of trace statement byte code into the compiled source code. The insertion module executes the insertion code and inserts the trace statement byte code into the compiled source code. The insertion module may insert the trace statement byte code at build time or at run time. Additionally, a template may define where to insert the trace statement byte code within the compiled source code.

### BACKGROUND OF THE INVENTION

1. Field of the Invention

This invention relates to software development and more particularly relates to template-based, byte code insertion of trace statements.

2. Description of the Related Art

Tracing is an important part of software development. Conventional tracing allows an application programmer or user to analyze the flow of data through the processing logic of the software. In particular, tracing statements may be added to the program source code to indicate the status of variables and other indicators at the entry and exit of a function. Tracing may also indicate the status of variables when an exception occurs. By including tracing options in a product, the product offers a level of serviceability to its customers.

There are two general, conventional approaches to Java trace insertion. First, there is a manual approach, which involves going through source code and manually inserting trace statements. Second, there exist trace statement insertion programs that facilitate Java trace insertion through automated source code modification. For example, products like AutoTrace and ANTLR (for custom parser generation) may help a programmer insert trace statements into the source code. Both of these conventional trace insertion approaches have associated drawbacks, some of which are highlighted below.

Manual insertion of entry, exit, and exception trace statements typically requires significant time and effort on the part of the programmer. Even with the use of tools to aid in the process (for example, the Eclipse/WebSphere Application Developer (WSAD) Reusable Asset (RAS) plug-in), manual trace statement insertion requires a significant amount of development time and effort. Manual insertion of trace statements is also subject to human error. Manual trace statement insertion allows, for example, misspelled method names and overlooked classes. Minor mistakes can significantly impact product serviceability. Manual trace insertion also requires substantial code management and maintenance. Changes in method names or the addition of new classes or methods makes it difficult to track which portions of the program code contain tracing and to what extent. Manual trace insertion also generates undesirable clutter in the source code. The addition of trace statements increases the size of the source code and makes it more difficult to later review the source code, if necessary.

Automated insertion of entry, exit, and exception trace statements into the source code has similar disadvantages. Additionally, products that facilitate automated trace statement insertion place limitations on the resulting program. For example, AutoTrace limits the program flexibility in terms of how tracing is performed and the format of the generated output. Also, a product using AutoTrace must ship with specific AutoTrace libraries, increasing the size of the product. Furthermore, both ANTLR and AutoTrace increase the complexity of trace insertion because these programs can be difficult to learn and use effectively.

From the foregoing discussion, it should be apparent that a need exists for an apparatus, system, and method that overcome the limitations of conventional manual and automated insertion of trace statements into application code. Beneficially, such an apparatus, system, and method would avoid the need for substantial changes to the source code, including increased size, increased complexity, and the potential for human error.

### SUMMARY OF THE INVENTION

The several embodiments of the present invention have been developed in response to the present state of the art, and in particular, in response to the problems and needs in the art that have not yet been fully solved by currently available trace insertion systems. Accordingly, the present invention has been developed to provide an apparatus, system, and method for inserting trace statements that overcome many or all of the above-discussed shortcomings in the art.

Embodiments of this invention facilitate making entry, exit, and exception trace statement insertion an automated build-time operation. Certain embodiments employ custom Ant extensions and modified Byte Code Engineering Library (BCEL) utilities to perform template-based code injection into compiled binaries. Ant is a java-based build tool. The BCEL allows users to analyze, create, and manipulate binary class files.

The apparatus to insert a trace statement is provided with a logic unit containing a plurality of modules configured to functionally execute the necessary operations for trace statement insertion. These modules in the described embodiments include an infrastructure module, an interface module, a template module, a generation module, an insertion module, and a source code module.

In one embodiment, the infrastructure module uses a logging infrastructure to implement a trace template interface. In one embodiment, the interface module defines the trace template interface, which may include one or more trace statements. The trace statements may be compiled into trace statement byte code that may be inserted into a compiled class file. In one embodiment, the template module defines where to insert the trace statement byte code within the compiled class file or compiled source code.

In one embodiment, the generation module generates an insertion code to facilitate insertion of the trace statement byte code into the compiled source code. The generation module may employ a modified BCELifier utility (from the Byte Code Engineering Library) to generate the insertion code. In one embodiment, the insertion module executes the insertion code and inserts the trace statement byte code into the compiled source code. The location at which the insertion module inserts the trace statement byte code into the compiled source code may depend on the compiled source code as well as the type of trace statement to which the trace statement byte code corresponds. For example, if the trace statement byte code corresponds to an entry trace statement, then the insertion module may insert the trace statement byte code at about a functional beginning of the class file byte code. Similarly, if the trace statement byte code corresponds to an exit trace statement, then the insertion module may insert the trace statement byte code at about a functional end of the class file byte code. Additionally, if the trace statement byte code corresponds to an exception trace statement then the insertion module may insert the trace statement byte code at about a functional exception of the class file byte code. The foregoing references to the functional beginning, end, and exception of the byte code refer to the functional aspect of a compiled class file. The functional beginning is at or near the invocation of the class file function. The functional end is at or near the completion of the class file function. The functional exception is at or near the invocation of an exception during the execution of the class file function.

In another embodiment, the insertion module also employs a custom Ant extension to insert the trace statement byte code into the compiled source code. The insertion module may insert the trace statement byte code into the compiled source code at build time, run time, or some time in between. In a further embodiment, the insertion module may determine if a trace flag is set prior to inserting the trace statement byte code into the compiled source code. In one embodiment, the source code module identifies the compiled source code. The compiled source code may be class file byte code or another type of byte code.

A system of the present invention is also presented to insert a trace statement. The system may be embodied in a trace insertion system having a compiler, an electronic storage device, and a trace insertion apparatus. The compiler compiles source code into a compiled class file. The electronic storage device stores the compiled class file. The trace insertion apparatus creates an augmented class file through insertion of trace statement byte code into the compiled class file. The system also may include a user interface and a Java runtime environment.

A signal bearing medium is also presented to store a program that, when executed, performs operations to insert a trace statement. In one embodiment, the operations include identifying compiled source code, generating an insertion code to facilitate insertion of trace statement byte code into the compiled source code, executing the insertion code, and inserting the trace statement byte code into the compiled source code.

In further embodiments, the operations may include defining where to insert the trace statement byte code within the compiled source code and/or defining a trace template interface that defines a trace statement that, when compiled, produces the trace statement byte code. In further embodiments, the operation may include inserting the trace statement byte code, corresponding to an entry trace statement, at about a functional beginning of the class file byte code, inserting the trace statement byte code, corresponding to an exit trace statement, at about a functional end of the class file byte code, and/or inserting the trace statement byte code, corresponding to an exception trace statement, at about a functional exception of the class file byte code

The presented embodiments of the apparatus, system, and method advantageously apply byte code modification to the task of trace statement insertion and also may use a template to drive the trace insertion. Using a template masks complexity and enables ease of use. Byte code injection is performed on behalf of the user without the user having to know how byte code actually works.

Relative to the conventional trace insertion technologies, using template-based, build-time trace insertion presents several advantages. In certain embodiments, for example, an application developer may save time and effort without having to manually insert the trace statements. Development efforts can be allocated to more important issues. Additionally, by inserting trace statements following compilation of the source code, the trace statements do not need to appear in the source code, reducing clutter in the code base. The automated nature of the trace statement insertion may significantly reduce the potential for human error, which may increase the serviceability of the resulting product. Tracking which files contain tracing is reduced to examining invocations of the custom Ant task in the XML build script. Additionally, it becomes possible to both alter the manner in which tracing is performed and change which set of classes contain tracing by recompiling the source code.

In additional embodiments, the product overhead is minimized by eliminating the need to ship custom libraries, making it possible to integrate with existing logging infrastructures. Furthermore, from a developer's perspective, using the approach described herein is simplified to implementation of an interface. Alternative embodiments also offer additional advantages, such as run-time trace insertion using modified class loaders and the use of an existing logging infrastructure to add entry, exit, and exception trace statements to third party libraries.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a trace insertion system;

FIG. 2 is a schematic block diagram illustrating one embodiment of a trace insertion apparatus;

FIG. 3 is a schematic block diagram illustrating one embodiment of a generation subsystem;

FIG. 4 is a schematic block diagram illustrating one embodiment of an insertion subsystem;

FIG. 5 is a schematic flow chart diagram illustrating one embodiment of a source code method;

FIG. 6 is a schematic flow chart diagram illustrating one embodiment of car a trace method; and

FIG. 7 is a schematic flow chart diagram illustrating one embodiment of a generation method.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

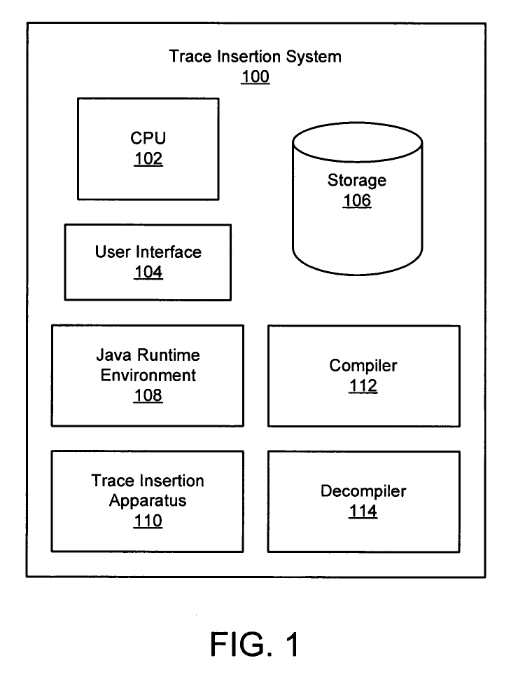

FIG. 1 depicts one embodiment of a trace insertion system 100. The illustrated trace insertion system 100 includes a central processing unit (CPU) 102, a user interface 104, and an electronic storage device 106. The illustrated trace insertion system 100 also includes a Java runtime environment (JRE) 108, a trace insertion apparatus 110, a compiler 112, and a decompiler 114.

The CPU 102 processes arithmetic and logical operations, as well as control instructions. In one embodiment, the user interface 104 includes equipment to facilitate entry of user commands into the trace insertion system 100. The user interface 104 may include hardware, such as keyboards, visual displays, and the like, and software, such as a command prompt, a graphical user interface (GUI), menus, and the like. In one embodiment, the user interface 104 allows a user to define a trace template interface, as described in more detail below.

The JRE 108 is a subset of the Java Software Development Kit (SDK) that contains the core executables and files that constitute the standard Java platform. The JRE 108 includes the Java virtual machine (JVM), core classes, and supporting files. The JVM is a software implementation of a central processing unit that runs compiled Java code (applets and applications). Java source code files are compiled into byte code format (typically with a .class extension) that can be executed by the JVM. Alternatively, byte code files may be converted directly into machine language instructions.

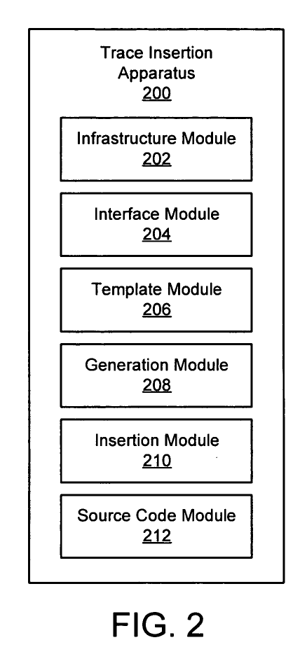

The trace insertion apparatus 110 facilitates automated insertion of trace statements into compiled byte code files (also referred to as compiled binaries). In certain embodiments, the trace insertion apparatus 110 implements template-based trace insertion into the compiled binaries. One example of a trace insertion apparatus 110 is shown in and described in more detail with reference to FIG. 2.

The compiler 112 generally converts Java source code into byte code, which may be processed by the JVM within the JRE 108. Alternatively, the compiler 112 may convert the source code into machine language instructions that may be executed by the CPU 102. The decompiler 114 converts byte code (or executable machine language instructions) into source code, or a variation of the original source code. Although a decompiler 114 is included in the illustrated trace insertion system 100, a decompiler 114 is not necessary for certain embodiments of the trace insertion system 100.

FIG. 2 depicts one embodiment of a trace insertion apparatus 200 that is substantially similar to the trace insertion apparatus 110 of FIG. 1. The illustrated trace insertion apparatus 200 includes an infrastructure module 202, an interface module 204, a template module 206, a generation module 208, an insertion module 210, and a source code module 212.

In one embodiment, the infrastructure module 202 uses a logging infrastructure to implement a trace template interface. The logging infrastructure defines what code is used to implement the tracing and may include one or more trace statements. In one embodiment, the interface module 204 defines the trace template interface. The trace statements may be compiled into trace statement byte code that may be inserted into a compiled class file. In one embodiment, the template module 206 defines where to insert the trace statement byte code within the compiled class file or compiled source code.

Implementation of a trace insertion interface via a template using a logging infrastructure addresses the following issues. The template may indicate how to initialize the object used to perform tracing. The template may indicate how to determine if tracing is enabled. The template may indicate what code should be executed if entry tracing is enabled. The template may indicate what code should be executed if exit tracing is enabled. The template may indicate what code should be executed if exception tracing is enabled. One example of a trace template interface, which may be defined by the interface module 204 and implemented by the infrastructure module 202, may be similar to the following:

public interface TraceTemplate {

public void initializeTraceLogger( );
public boolean isTraceEnabledO( );
public void doTraceEntry(string clazz, String method);
public void doTraceEntry(String clazz, String method,
object[] argArray);
public void doTraceExit(String clazz, string method);
public void doTraceExit(String clazz, string method,
object result);
public void doTraceException(String clazz, string
method, Throwable t);

}

In the foregoing example, the arguments taken by each method represent what information might be available to provide an appropriate level of tracing. For example, when tracing entry into a method, it may be beneficial to capture the name of the method, the class in which the method is defined, and the arguments, if any, passed to the method when it was invoked. Similar arguments might be taken for exit and exception tracing. In one embodiment, the exemplary trace template interface also includes a static variable representing the tracer. One example of an implementation of the trace insertion interface may be similar to the following:

public class SampleTraceTemplateImpl implements TraceTemplate {

private static PrintStream traceLogger;
public void initializeTraceLogger( ) {

traceLogger = System.err;

}
public boolean isTraceEnabled( ) {

return true;

}
public void doTraceEntry(String clazz, String method) {

traceLogger.println(“traceEntry(clazz, method) [” +

clazz + “, ” + method + “]”);

}
public void doTraceEntry(String clazz, String method,
Object[] argArray){

traceLogger.println(“traceEntry(clazz, method,
argArray) [” +

clazz + “, ” + method + “, ” +
argArray + “]”);

}
public void doTraceExit(String clazz, String method) {

traceLogger.println(“traceExit(clazz, method) [” +

clazz + “, ” + method + “]”);

}
public void doTraceExit(String clazz, String method,
Object result) {

traceLogger.println(“traceExit(clazz, method,
result) [” +

clazz + “, ” + method + “, ” +
result + “]”);

}
public void doTraceException(String clazz, String
method, Throwable t) {

traceLogger.println(“traceException(clazz,
method, t) [” +

clazz + “, ” + method + “, ” +
t + “]”);

}

}

In one embodiment, the foregoing class corresponds to the template module 206. Furthermore, the code in each method of the foregoing class may be defined by the infrastructure module 202.

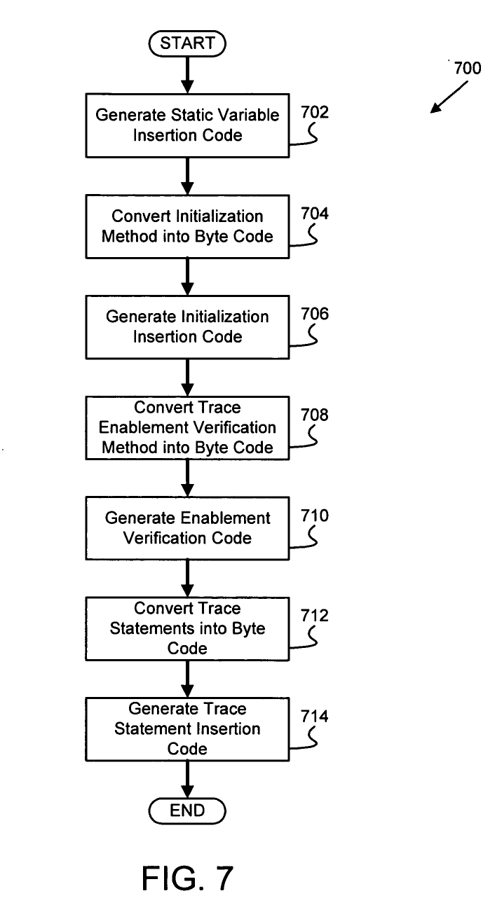

In one embodiment, the generation module 208 generates an insertion code to facilitate insertion of the trace statement byte code into the compiled source code. In a further embodiment, the generation module 208 may employ a modified BCELifier utility to generate the insertion code. (The BCELifier utility is a utility within the Byte Code Engineering Library (BCEL) that receives a compiled class file as input and generates a java source file that, when compiled and run, generates a class file. BCEL is an open source, byte code modification framework; see http://jakarta.apache.org/bcel/.) In one embodiment, the BCELifier utility is modified to perform the operations depicted in and described in more detail with reference to FIG. 7.

In one embodiment, the insertion module 210 executes the insertion code and inserts the trace statement byte code into the compiled source code. The location at which the insertion module 210 inserts the trace statement byte code into the compiled source code may depend on the compiled source code as well as the type of trace statement to which the trace statement byte code corresponds. For example, if the trace statement byte code corresponds to an entry trace statement then the insertion module 210 may insert the trace statement byte code at about a functional beginning of the class file byte code. Similarly, if the trace statement byte code corresponds to an exit trace statement then the insertion module 210 may insert the trace statement byte code at about a functional end of the class file byte code. Additionally, if the trace statement byte code corresponds to an exception trace statement then the insertion module 210 may insert the trace statement byte code at about a functional exception of the class file byte code. The foregoing references to the functional beginning, end, and exception of the byte code refer to the functional aspect of a compiled class file. The functional beginning is at or near the invocation of the class file function. The functional end is at or near the completion of the class file function. The functional exception is at or near the invocation of an exception during the execution of the class file function.

In another embodiment, the insertion module 210 also employs a custom Ant extension to insert the trace statement byte code into the compiled source code. (Ant is an open source, Java-based build tool; see http://ant.apache.org/.) The insertion module 210 may insert the trace statement byte code into the compiled source code at build time, run time, or some time in between. In a further embodiment, the insertion module 210 may determine if a trace flag is set prior to inserting the trace statement byte code into the compiled source code.

In one embodiment, the source code module 212 identifies the compiled source code. The compiled source code may be class file byte code or another type of byte code.

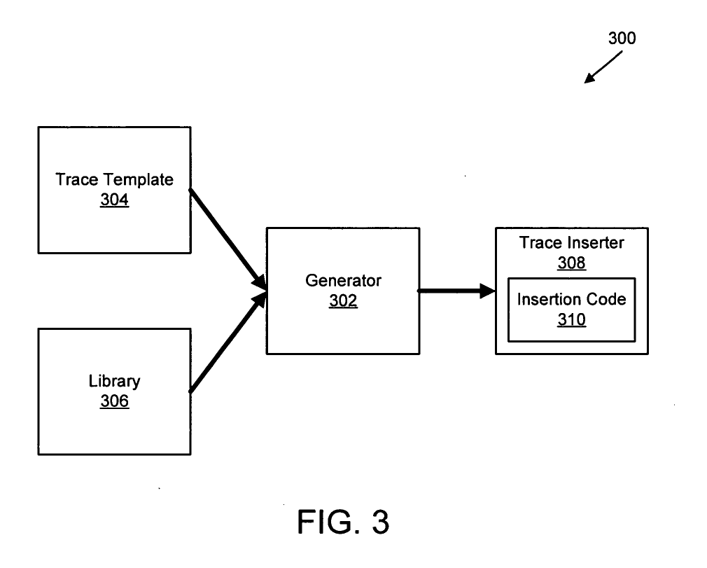

FIG. 3 depicts one embodiment of a generation subsystem 300 that may be used in conjunction with the trace insertion apparatus 200 of FIG. 2. The illustrated generation subsystem 300 includes a generator 302, a trace template 304, a library 306, and a trace inserter 308. In one embodiment, the generator 302 is similar to the generation module 208 of FIG. 2. Additionally, the trace inserter 308 may be similar to the insertion module 210 of FIG. 2. The trace inserter 308 also may include an insertion code 310 produced by the generator 302. Alternatively, the trace inserter 308 may be coupled to the insertion code 310.

In one embodiment, the trace template 304 and the library 306 are input into the generator 302. In turn, the generator 302 produces the trace inserter 308, including the insertion code 310, to insert trace statement byte code into compiled source code. The trace template 304 may be defined by the template module 206. The library 306 may be the BCEL or another library of utilities. Furthermore, the library 306 may be a modified version of part or all of the BCEL or another byte code modification library.

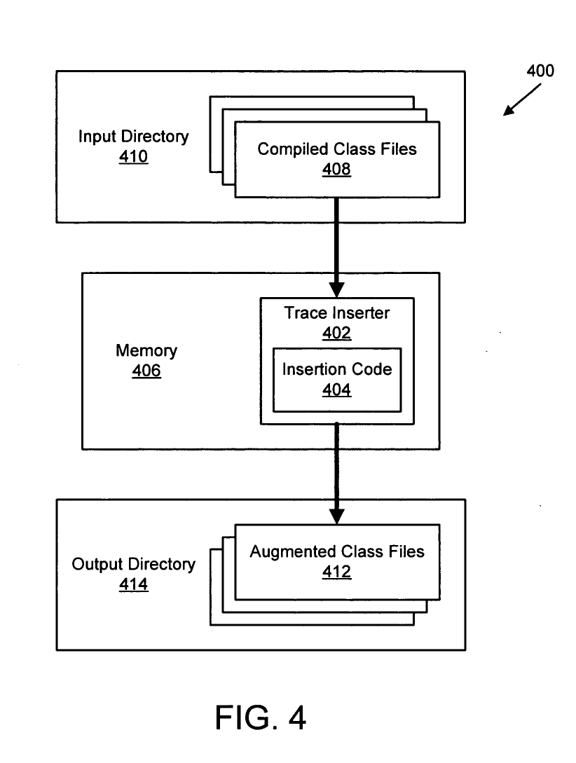

FIG. 4 depicts one embodiment of an insertion subsystem 400 that may be used in conjunction with the trace insertion apparatus 200 of FIG. 2. The illustrated insertion subsystem 400 includes a trace inserter 402 and an insertion code 404 that are substantially similar to the trace inserter 308 and insertion code 310, respectively, of FIG. 3. In one embodiment, the trace inserter 402 and insertion code 404 may be stored in an electronic memory device 406. Alternatively, the trace inserter 402 and insertion code 404 may be stored in another electronic storage device, such as the electronic storage device 106 of FIG. 1. In another embodiment, the trace inserter 402 and insertion code 404 may be stored in separate electronic memory or storage device that are coupled together.

The trace inserter 402 receives as input a compiled class file 408 stored in an input directory 410. The compiled class file 408 is compiled source code. The trace inserter 402 then creates an augmented class file 412 and stores the augmented class file 412 in an output directory 414. The augmented class file 412 is similar to the compiled class file 408, except that the augmented class file 412 includes trace statement byte code corresponding to entry, exit, and/or exception trace statements. The input directory 410 and the output directory 414 may be located on a single electronic storage device or on separate electronic storage devices. In one embodiment, the input directory 410 and the output directory 414 are designated in the custom Ant extension. For example, a task tag associated with the custom Ant extension may be inserted into an XML build script. One example of the task tag may be similar to the following:

<injectTrace

traceTemplate=“com.ibm.product.SampleTraceTemplatelmpl”
inputDirectory=“${basedir}/build.out/java”
outputDirectory=“${basedir}/build.out/java_trace” />

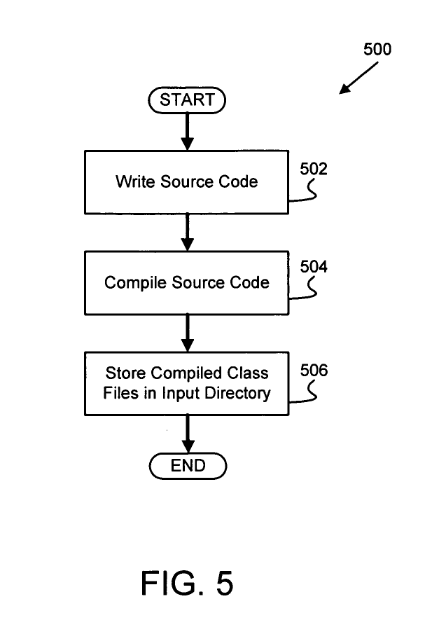

FIG. 5 depicts one embodiment of a source code method 500. The source code method 500 describes one example of how compiled class files 408 may be produced and stored in the input directory 410. The source code method 500 may be implemented in conjunction with the trace insertion system 100 of FIG. 1. The illustrated source code method 500 includes writing 502 source code, compiling 504 the source code, and storing the compiled class files 408 in the input directory 410.

More particularly, a developer may write 502 the source code in a programming language, such as Java. In one embodiment, the developer writes 502 one or more .java source files. The developer subsequently compiles 504 the source code to form compiled .class class files that are in byte code format. In one embodiment, the compiler 112 actually compiles the source files and stores 506 the compiled class files 408 in the input directory 410. Alternatively, the compiled class files 408 may be stored in another directory by the compiler 112 and moved or copied to the input directory 410.

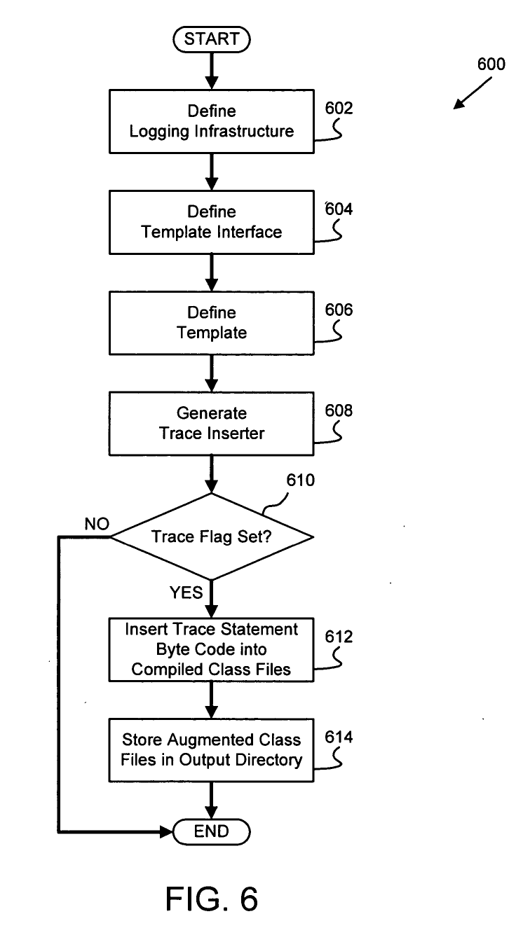

FIG. 6 depicts one embodiment of a trace method 600. The trace method 600 describes one example of how compiled class files 408 may be used to create augmented class files 412. Although some operations of the trace method 600 may be executed after the completion of the source code method 500 of FIG. 5, some of the operations of the trace method 600 may be executed before or substantially concurrently with the execution of the part or all of the source code method 500. The trace method 600 may be implemented in conjunction with the trace apparatus 200 of FIG. 2.

The illustrated trace method 600 begins and the logging infrastructure module 202 defines 602 the logging infrastructure. In one embodiment, the logging infrastructure defines what code is used to implement the tracing. The interface module 204 then defines 604 a trace template interface, which is implemented by the infrastructure module 202. As described above, the interface module 204 defines a trace statement that, when implemented and compiled, produces the trace statement byte code. The template module 206 then defines 606 a trace template 304, which defines where to insert the trace statement byte code within the compiled class files 408.

Using the trace template 304 and the library 306, the generator 302 then generates 608 the trace inserter 308, including the insertion code 310. In one embodiment, the insertion code 310 is a class file capable of inserting entry, exit, and/or exception trace statements in byte code format into the compiled class files 408. Furthermore, the insertion code 310 may be stored in an electronic memory device 406 or in another electronic storage device. As described above, the generator 302 may employ a modified BCELifier utility. One example of the operations performed by the generator 302 is described in more detail with reference to FIG. 7.

The depicted trace method 600 continues as the insertion module 210 determines 610 if a trace flag is set. In one embodiment, the trace flag is a Boolean variable that may be set or cleared by a user or client. If the trace flag is set, the trace inserter 402 executes the insertion code and inserts 612 the trace statement byte code at the locations specified in the trace template interface. In another embodiment, an individual trace flag may be used for each compiled class file 408 so that each trace statement byte code may be inserted into individual compiled class files 408.

The trace inserter 402 then stores 614 the augmented class files 412 in the output directory 414. If there are multiple compiled class files 408 in the input directory 410, the trace inserter may recursively iterate through the compiled class files 408 and invoke the insertion code 310 against each compiled class file 408. After storing 614 the augmented class files 412, or if the trace flag is not set, the illustrated trace method 600 ends. As described above, the trace inserter 402 may create the augmented class files 412 at build time, as described herein, at run time, such as through a modified class loader, or at another time.

FIG. 7 depicts one embodiment of a generation method 700 that is given by way of example of the generation operation 608 of the trace method 600 of FIG. 6. The generation method 700 may be executed by the generation module 208 or the generator 302. In one embodiment, the modified BCELifier utility facilitates the generation method 700.

The illustrated generation method 700 begins and the generator 302 generates 702 a static variable insertion code. The static variable insertion code, when executed, inserts a static variable declared in the trace template into a compiled class file 408. The generator 302 then converts 704 an initialization method into byte code and generates 706 an initialization insertion code. In one embodiment, the initialization method is defined in the trace template, for example the initializeTraceLogger( ) method. The initialization insertion code, when executed, inserts the insertion code in byte code format into the static initialization block of the compiled class file 408.

The generator 302 then converts 708 a trace enablement verification method into byte code and generates 710 an enablement verification code. In one embodiment, the enablement verification method is defined in the trace template, for example the checkTraceEnabled( ) method. The enablement verification code, when executed, inserts the enablement verification method, in byte code format, into the beginning of a method contained in the compiled class file 408. In one embodiment, the result of the execution of the enablement verification byte code is stored in a local Boolean variable.

The generator 302 then converts 712 each entry, exit, and/or exception trace statement into byte code and generates 714 a trace statement insertion code 310. In one embodiment, the entry, exit, and/or exception trace statements are defined in the trace template, for example the doTraceEntry( ), doTraceExit( ), and/or doTraceException( ) methods. The trace statement insertion code 310, when executed, inserts the appropriate trace statement byte code into the appropriate location of a compiled class file 408. In one embodiment, the insertion code 310 verifies, prior to inserting the trace statement byte code, that the trace flag (the local Boolean variable) is set and that the placement of certain information, such as a class name, is on the stack to be processed. The depicted generation method 700 then ends.

One example of a source file that has not been compiled or augmented to include trace statement byte code may be similar to the following:

public class SampleClass {

public Sampleclass( ) {

// SampleClass initialization code . . .

}
public String doSomething(String filename) throws
RuntimeException {

String result = null;
try {

// Load result from somewhere on filesystem . . .

} catch (IOException ioe) {

throw new RuntimeException(ioe);

}
return result;

}
public static void main(String[] argArray) {

Sampleclass sc = new Sampleclass( );
System.out.println(sc.doSomething(“sample.txt”));

}

}

One example of a decompiled augmented class file 408 that includes trace statement byte code may be similar to the following:

public class SampleClass {

private static PrintStream traceLogger;
static {

traceLogger = System.err;

}
public SampleClass( ) {

boolean traceEnabled = true;
if (traceEnabled) {

String clazz = “SampleClass”;
String method = “SampleClass”;
// Code from doTraceEntryQ . . .

}
// SampleClass initialization code . . .
if (traceEnabled) {
String clazz = “SampleClass”;
String method = “SampleClass”;
// Code from doTraceExit( )
}

}
public string doSomething(String filename) throws
RuntimeException {

boolean traceEnabled = true;
if (traceEnabled) {

String clazz = “SampleClass”;
string method “doSomething”;
Object[] argArray =
new Object[] { filename };
// code from doTraceEntry( ) . .

}
String result = null;
try{

// Load result from somewhere on filesystem

} catch (IOException ioe) {

if (traceEnabled) {

String clazz = “SampleClass”;
String method = “doSomething”;
Throwable t = ioe;
// Code from doTraceException( ) . . .

}
throw new RuntimeException(ioe);

}
if (traceEnabled) {

String clazz = “SampleClass”;
String method = “doSomething”;
Object returnValue = result;
// Code from doTraceExit( ) . . .

}
return result;

}
public static void main(String[] args) {

boolean traceEnabled = true;
if (traceEnabled) {

String clazz = “Sampleclass”;
String method = “main”;
Object[] argArray = new Object[] { args };
// code from doTraceEntry( ) . . .

SampleClass sc = new SampleClass( );
Systern.out.println(sc.doSomething(“sample,txt”));
if (traceEnabled) {

String clazz = “Sampleclass”;
String method = “main”;
// Code from doTraceExit( ) . . .

}

}

}

The foregoing examples are included to portray one embodiment of a pre-compilation source file and a decompiled augmented class file. Other embodiments may produce other exemplary codes, operations, and methods. For example, certain embodiments might avoid placing information in local variables before invoking the insertion code 310.

Advantageously, the presented embodiments apply byte code modification to trace statement insertion and also may use a template to drive the trace insertion. Using a template masks complexity and enables ease of use. Byte code injection is performed on behalf of the user without the user having to know how byte code actually works.

Relative to the conventional trace insertion technologies, using template-based, build-time trace insertion presents several advantages. In certain embodiments, for example, an application developer may save time and effort without having to manually insert the trace statements. Development efforts can be allocated to more important issues. Additionally, by inserting trace statements following compilation of the source code, the trace statements do not need to appear in the source code, reducing clutter in the code base. The automated nature of the trace statement insertion may significantly reduce the potential for human error, which may increase the serviceability of the resulting product. Tracking which files contain tracing is reduced to examining invocations of the custom Ant task in the XML build script. Additionally, it becomes possible to both alter the manner in which tracing is performed and change which set of classes contain tracing by recompiling the source code. In additional embodiments, the product overhead is minimized by eliminating the need to ship custom libraries, making it possible to integrate with existing logging infrastructures. Furthermore, from a developer's perspective, using the approach described herein is simplified to implementation of an interface. Alternative embodiments also offer additional advantages, such as run-time trace insertion using modified class loaders and the use of an existing logging infrastructure to add entry, exit, and exception trace statements to third party libraries.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to insert a trace statement, the apparatus comprising:
a source code module configured to identify compiled source code;
a generation module coupled to the source code module, the generation module configured to generate an insertion code to facilitate insertion of trace statement byte code into the compiled source code; and
an insertion module coupled to the generation module, the insertion module configured to execute the insertion code and insert the trace statement byte code into the compiled source code.

2. The apparatus of claim 1, further comprising a template module coupled to the generation module, the template module configured to define where to insert the trace statement byte code within the compiled source code.

3. The apparatus of claim 1, further comprising an infrastructure module coupled to the generation module, the infrastructure module configured to implement a trace template interface.

4. The apparatus of claim 3, further comprising an interface module coupled to the infrastructure module, the interface module configured to define a trace template interface, which defines a trace statement that, when compiled, produces the trace statement byte code.

5. The apparatus of claim 1, wherein the compiled source code comprises class file byte code.

6. The apparatus of claim 5, wherein the trace statement byte code corresponds to an entry trace statement and the insertion module is further configured to insert the trace statement byte code at about a functional beginning of the class file byte code.

7. The apparatus of claim 5, wherein the trace statement byte code corresponds to an exit trace statement and the insertion module is further configured to insert the trace statement byte code at about a functional end of the class file byte code.

8. The apparatus of claim 5, wherein the trace statement byte code corresponds to an exception trace statement and the insertion module is further configured to insert the trace statement byte code at about a functional exception of the class file byte code.

9. The apparatus of claim 1, wherein the generation module employs a modified BCELifier utility to generate the insertion code.

10. The apparatus of claim 1, wherein the insertion module employs a custom Ant extension to insert the trace statement byte code into the compiled source code.

11. The apparatus of claim 1, wherein the insertion module is further configured to insert the trace statement byte code into the compiled source code at run-time of the compiled source code.

12. The apparatus of claim 1, wherein the insertion module is further configured to insert the trace statement byte code in response to a determination that a trace flag is set.

13. A system to insert a trace statement, the system comprising:
a compiler to compile source code into a compiled class file;
an electronic storage device to store the compiled class file; and
a trace insertion apparatus to create an augmented class file through insertion of trace statement byte code into the compiled class file.

14. The system of claim 13, further comprising a template module coupled to the trace insertion apparatus, the template module configured to define where to insert the trace statement byte code within the compiled class file.

15. The system of claim 13, further comprising an infrastructure module coupled to the trace insertion apparatus, the infrastructure module configured to implement a trace template interface defining a trace statement that, when implemented and compiled, produces the trace statement byte code.

16. The system of claim 15, further comprising a user interface to allow a user to define the trace template.

17. The system of claim 13, further comprising a Java runtime environment to execute the augmented class file.

18. A signal bearing medium tangibly embodying a program of machine-readable instructions executable by a digital processing apparatus to perform operations to insert a trace statement, the operations comprising:
identifying compiled source code;
generating an insertion code to facilitate insertion of trace statement byte code into the compiled source code;
executing the insertion code; and
inserting the trace statement byte code into the compiled source code.

19. The signal bearing medium of claim 18, wherein the instructions further comprise an operation to define where to insert the trace statement byte code within the compiled source code.

20. The signal bearing medium of claim 18, wherein the instructions further comprise an operation to implement a trace template interface that defines a trace statement that, when implemented and compiled, produces the trace statement byte code.

21. The signal bearing medium of claim 18, wherein the instructions further comprise an operation to insert the trace statement byte code, corresponding to an entry trace statement, at about a functional beginning of the class file byte code.

22. The signal bearing medium of claim 18, wherein the instructions further comprise an operation to insert the trace statement byte code, corresponding to an exit trace statement, at about a functional end of the class file byte code.

23. The signal bearing medium of claim 18, wherein the instructions further comprise an operation insert the trace statement byte code, corresponding to an exception trace statement, at about a functional exception of the class file byte code.

24. A method for deploying computer infrastructure, comprising integrating computer-readable code into a computing system, wherein the code in combination with the computing system is capable of inserting a trace statement by performing the following:
identifying compiled source code;
generating an insertion code to facilitate insertion of trace statement byte code into the compiled source code;
executing the insertion code; and
inserting the trace statement byte code into the compiled source code.

25. The method of claim 24, wherein the code in combination with the computing system is further capable of defining where to insert the trace statement byte code within the compiled source code.

26. The method of claim 24, wherein the code in combination with the computing system is further capable of implementing a trace template interface that defines a trace statement that, when implemented and compiled, produces the trace statement byte code.

27. The method of claim 24, wherein the code in combination with the computing system is further capable of inserting the trace statement byte code, corresponding to an entry trace statement, at about a functional beginning of the class file byte code.

28. The method of claim 24, wherein the code in combination with the computing system is further capable of inserting the trace statement byte code, corresponding to an exit trace statement, at about a functional end of the class file byte code.

29. The method of claim 24, wherein the code in combination with the computing system is further capable of inserting the trace statement byte code, corresponding to an exception trace statement, at about a functional exception of the class file byte code.

30. An apparatus to insert a trace statement, the apparatus comprising:
means for identifying compiled source code;
means for generating an insertion code to facilitate insertion of trace statement byte code into the compiled source code;
means for executing the insertion code; and
means for inserting the trace statement byte code into the compiled source code.
